(19) United States
(12) Patent Application Publication
(10) Pub. No.: US 2010/0108834 A1
(43) Pub. Date: May 6, 2010

(54) Multi-purpose hanger

(75) Inventor: Peter E. Rigas, Yardley, PA (US)

Correspondence Address: DEIRDRA M. MEAGHER, ESQ.;GLYNNTECH, INC., 24 Mine Street, Flemington, NJ, 08822, US

(73) Assignee: PLEO ORIGINALS, LLC

(21) Appl. No.: 12/653,025

(22) Filed: Dec. 8, 2009

Related U.S. Application Data
(63) Continuation-in-part of application No. 12/291,588, filed on Nov. 12, 2008.
Application No. 12/291,588 is a continuation-in-part of application No. 11/439,430, filed on May 24, 2006, now Pat. No. 7,595,352.

(51) Int. Cl. F16M 13/00; A47G 25/06; E05D 5/10

(52) U.S. Cl. 248/213.1; 16/386

(57) ABSTRACT

A multi-purpose hanger includes a frame having a plurality of sequential coat hanger-receiving slots. The frame has a door hinge pin connector at one of its first end and second end that includes a connector member and a vertical shaft-receiving orifice for attachment to a door hinge and door hinge pin. The frame has a closet hanger rod hook for attachment to a closet hanger rod. A multi-purpose hanger system includes the aforesaid hanger and a hinge pin with a separate top for the hanger connector and bottom for a door hinge.

### REFERENCE TO RELATED PATENT APPLICATIONS

This application is a continuation-in-part of copending U.S. patent application Ser. No. 12/291,588 filed on Nov. 12, 2008, entitled “Hinge Pin” by the same inventor which itself is a continuation-in-part of U.S. patent application Ser. No. 1/439,430 filed on May 23, 2006, entitled “Versatile Telescopic Door Hinge Hanger” by the same inventor herein, now abandoned.

### BACKGROUND OF INVENTION

a. Field of Invention

The present invention generally to relates to devices for hanging and for transporting any item on hangers, such as clothes. The present invention devices may, for example, be used for hanging clothes that are wet and need to be hung for drying, clothes that are in the ironing stage, clothes that are put out for subsequent dressing, and cloth items, e.g. towels and washcloths, as well as such items that merely need temporary or closet-alternative storing with mobility options. The present invention devices are hangable on rods and are also hangable where rods are unavailable by being hung on modified door hinge pins. Thus, the present invention is directed to devices that not only attach to the pin area of a door hinge, so as to be conveniently located but not be intrusive or obstructive, but they are also removable from the pin and may be hooked on a closet or other rod or on other supports, such as a vehicle overhead hand strap. Due to the removable feature, they may be moved from location to location with the clothes remaining thereon. In some of its preferred embodiments, a replacement hinge pin is included that has an upper section that permits one-step sliding of the device onto it and off it. This permits easy installation as well as device portability. For example, the device is easily moved from a laundry room to a TV room where ironing may be done, and then to a closet.

b. Description of Related Art

The following patents are representative of the field pertaining to the present invention:

U.S. Pat. No. 7,080,727 B1 describes a system, apparatus and method for the handling, transport and or storage of items of wearing apparel which are hung on hangers. In the system, there is plurality or transport units which travel over a rail system from a first location (e.g. an inbound location) to a second location (e.g. an outbound location). Each transport unit has a carrier section which, in the first operating position of the transfer unit, is generally horizontally aligned, and is suspended from a rail by means of first and second roller support sections at opposite ends of the carrier section. The transport unit has a second operating position where the carrier section is rotated relative to one of the roller support sections to a more vertical orientation where the garment units are closer together in a horizontal direction and more vertically aligned with one another, this being a position in which the garment units can be stored and/or shipped in a more closely packed configuration.

U.S. Pat. No. 6,942,111 B2 describes a trolley that is utilized to transport garments or other articles over a rail system between desired locations. The trolley includes a support member and a plurality of trolley heads each disposed at a corresponding support member end. The trolley heads each include a housing with rollers disposed therein and an arm that connects that trolley head to a corresponding end of the support member. The rollers engage a slick rail system to enable the trolley, with the support member in a generally horizontal orientation, to transverse the rail system and transport garments suspended from the support member. One of the trolley ends includes a pivoting mechanism that enables the support member to pivot or swivel with respect to the trolley arm at the end to place the support member in a generally vertical position.

U.S. Pat. No. 5,505,317 describes a pivoting door hinge held catchall rack including a rod which extends vertically along a plurality of door hinges and which is held by the pins of the door hinges threaded through flanges on either end of the rod and/or through screw-eye type devices which are easily threaded into a slot in back of the rod and therefore can be readily aligned with the tops of the hinges. From the rod are extended, appended, fixed or attached a plurality of catchall, shapes and forms.

U.S. Pat. No. 5,501,345 describes a garment holder assembly supports garments while being disposed in either of two different attitudes. The assembly includes an elongated rigid support structure with a plurality of spaced, interior dividers. A hook extends from one or more dividers to support the garment holder assembly in a horizontal attitude. A link secured to one end of the support structure can be connected to a hook for supporting the assembly in a vertical attitude.

U.S. Pat. No. 5,425,462 describes a hinge pin clothes hanger to furnish a quality product made to last, that replaces the hinge pin of any door hinge with a hinge pin clothes hanger that, when properly installed, does not effect the operation of the door or the hinge into which it is being used. The hinge pin clothes hanger is a non-destructive support on which to hang clothes, towels or anything similar, on any door hinge, in any room in which it would be useful. It is easily installed or removed without any damage to the door or hinge. You simply remove the existing hinge pin and install the hinge pin clothes hanger in its place, or simply remove the hinge pin clothes hanger to restore the hinge to its original condition with the original hinge pin. It's that simple. Furthermore, when in use the hinge pin clothes hanger will provide a substantial means of support which will give the consumer years of reliable service and will blend into the decor of the room into which it is being used.

U.S. Pat. No. 5,117,987 discloses a garment support to be detachably mounted upon a door hinge of the type having intermeshing sleeves held together by a hinge pin. The invention comprises a hinge mounting member and a main body member. The hinge mounting member is substantially flat and elongated in shape containing an angled slot at one end capable of receiving the shaft of a hinge pin, and a centered oblong aperture. The main body member is substantially rectangular in shape containing an L-shaped end and a plurality of supports, whereby garments and other articles may be suspended.

U.S. Pat. No. 4,721,212 describes a modular article support unit consisting of an elongated tubular member adapted to be removably attached to the hinge pins of two hinges of a door by means of adjustable brackets, said elongated tubular member having a plurality of holes along the length thereof for removably attaching several types of support devices, such as coat hooks, towel racks, bulletin boards and mirrors.

U.S. Pat. No. 1,208,986 describes the combination of a hinge, an elongated pin carried thereby, and a hook mounted on said pin and provided with a bracing member engaging the hinge.

Notwithstanding the prior art, the present invention is neither taught nor rendered obvious thereby.

### SUMMARY OF INVENTION

The present invention is a multi-purpose that includes a frame having a plurality of coat hanger-receiving slots, the slots being arranged in a sequence, the frame having a first end and a second end, and having a door hinge pin connector at one of the first end and the second end, the connector having a connector member and having a vertical shaft-receiving orifice in the connector member for attachment to a door hinge and door hinge pin, the frame having a closet hanger rod hook at one of the first end and the second end for attachment to a closet hanger rod. The frame may be circular, semicircular, arcuate, rectilinear, elongated, symmetric or asymmetric and may be of any desired shape, although elongated shapes are preferred.

In some preferred embodiments of the present invention multi-purpose hanger, the slots are closed slots.

In some preferred embodiments of the present invention multi-purpose hanger, the slots are open slots.

In some preferred embodiments of the present invention multi-purpose hanger, the connector is at the first end of the frame and the hook is at the second end of the frame. In other preferred embodiments of the present invention multi-purpose hanger, the connector is at the first end of the frame and the hook is at the first end of the frame. In some preferred embodiments of the present invention multi-purpose hanger, the frame is elongated in a horizontal direction, the connector being located at the first end of the elongated frame, the hook being located at the second end of the elongated frame.

In some preferred embodiments of the present invention multi-purpose hanger, the multipurpose hanger is a single piece of material.

In some preferred embodiments of the present invention multi-purpose hanger, the multipurpose hanger is a material selected from the group consisting of plastic, metal and combinations thereof.

In some preferred embodiments of the present invention multi-purpose hanger, the multipurpose hanger is a plastic hanger.

In some preferred embodiments of the present invention multi-purpose hanger, the eframe has a first section that includes the hook and a second section that includes plurality of the coat hanger-receiving slots, and wherein the first section and the second section are rotatably connected to one another so as to be swiveled relative to one another.

Other preferred embodiments of the present invention are multi-purpose hanger systems. The present invention multi-purpose hanger system includes: a) a multi-purpose hanger, the multi-purpose hanger being an elongated frame having a plurality of coat hanger-receiving slots, the slots being arranged in a sequence, the frame having a first end and a second end, and having a door hinge pin connector at one of the first end and the second end, the connector having a connector member and having a vertical shaft-receiving orifice in and through the connector member for attachment to a door hinge and door hinge pin, the frame having a closet hanger rod hook at one of the first end and the second end for attachment to a closet hanger rod; and, b) a door hinge pin having an elongated shaft, the elongated shaft having an upper member, a lower member and a divider stop located between the upper member and the lower member, the upper member having a first maximum width and the lower member having a second maximum width and the stop having a third maximum width, wherein the third maximum width is greater than the second maximum width, and wherein the lower member is adapted to fit into a door hinge pin receiver, the stop is adapted to rest atop of the door hinge pin receiver and not fit into the door hinge pin receiver, and the upper member is adapted to fit into the vertical shaft receiving orifice of the multipurpose hanger.

In some preferred embodiments of the present invention multi-purpose hanger system, the one of the upper member and the lower member of the door hinge pin is circular from a top view.

In some preferred embodiments of the present invention multi-purpose hanger system, the hanger slots are closed slots.

In some preferred embodiments of the present invention multi-purpose hanger system, the hanger slots are open slots.

In some preferred embodiments of the present invention multi-purpose hanger system, the connector is at the first end of the elongated frame and the hook is at the second end of the elongated frame.

In some preferred embodiments of the present invention multi-purpose hanger system, the elongated frame is elongated in a horizontal direction, the connector being located at the first end of the elongated frame, the hook being located at the second end of the elongated frame.

In some preferred embodiments of the present invention multi-purpose hanger system, the connector is at the first end of the elongated frame and the hook is at the first end of the elongated frame.

In some preferred embodiments of the present invention multi-purpose hanger system, the multipurpose hanger is a single piece of material.

In some preferred embodiments of the present invention multi-purpose hanger system, the

In some preferred embodiments of the present invention multi-purpose hanger system, the multipurpose hanger is a material selected from the group consisting of plastic, metal and combinations thereof.

In some preferred embodiments of the present invention multi-purpose hanger system, the multipurpose hanger is a plastic hanger.

In some preferred embodiments of the present invention multi-purpose hanger system, the door hinge pin upper member maximum width is the same as the lower member maximum width.

In some preferred embodiments of the present invention multi-purpose hanger system, the frame has a first section that includes the hook and a second section that includes plurality of the coat hanger-receiving slots, and wherein said first section and said second section are rotatably connected to one another so as to be swiveled relative to one another.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a side view of an embodiment of a multi-purpose hanger system according to the present invention, illustrating the present invention hanger and door hinge pin apart;

FIG. 2 is a top view of the present invention hanger (without the pin) as shown in FIG. 1;

FIG. 3 is a side view of the multi-purpose hanger system according to the present invention as shown in FIG. 1, illustrating the present invention hanger and door hinge pin assembled together on a door hinge, also showing a partial view of a plurality of clothes hangers;

FIG. 4 is a side view of the multi-purpose hanger according to FIG. 1, but shown hanging on a closet rod instead of a modified door hinge pin;

FIG. 5 is a side view of the multi-purpose hanger according to FIG. 1, shown hanging on a closet rod, as in FIG. 4, but with clothes hangers added;

FIG. 6 is an alternative embodiment present invention multi-purpose hanger system, including a hinge pin;

FIG. 7 is another alternative embodiment present invention multi-purpose hanger, with both the rod hook and the hinge pin connector at the same end of the device;

FIG. 8 is yet another alternative embodiment present invention multi-purpose hanger, this one being articulated so that the hook section and the clothes hanger slots section are able to swivel (rotate) relative to one another; and,

FIG. 9 is an alternative embodiment present invention multi-purpose hanger that is articulated for swiveling and has an oval shape.

### DETAILED DESCRIPTION OF THE EMBODIMENTS

It should be noted that the present invention devices are for hanging and for transporting any item on hangers, such as clothes. The present invention devices may be used for hanging wet clothes for drying, clothes that need ironing, clothes that are put out for wearing, and for cloth items, e.g. clothes, towels and washcloths that merely need temporary or closet-alternative storing with mobility options. The present invention devices are hangable on rods and are also hangable where rods are unavailable by being hung on modified door hinge pins. The present invention devices not only attach to the pin area of a door hinge (conveniently located but not be intrusive or obstructive), but they are also removable from the pin and may be hooked on a closet or other rod or on other supports, such as an overhead hand strap of a car, minivan, bus or boat. Due to the removable feature, they may be moved from location to location with the clothes remaining thereon. A replacement hinge pin is included that has an upper section that permits one-step sliding of the device onto it and off it. This permits easy installation as well as device portability. For example, the device is easily moved from a laundry room to a TV room where ironing may be done, and then to a closet. (The terms “clothes hanger” and “coat hanger” are used interchangeably throughout this description.)

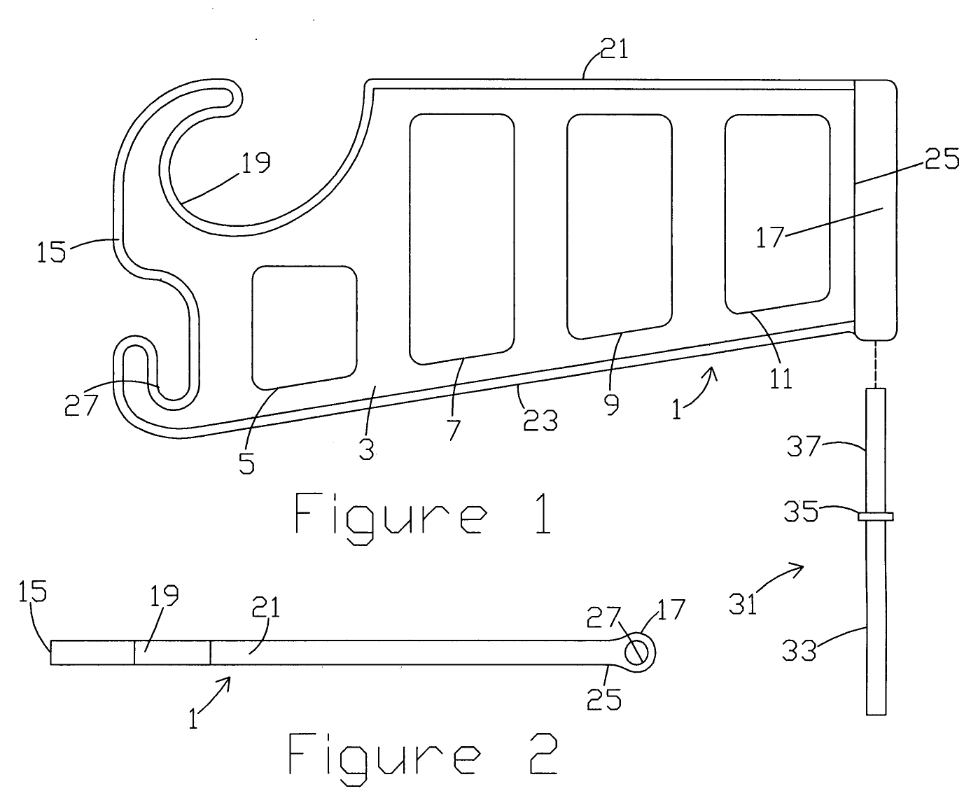

Referring now to the drawings, wherein like reference numerals designate corresponding parts throughout FIGS. 1 through 5, views, FIG. 1 is a side view of an embodiment of a multi-purpose hanger system according to the present invention, illustrating the present invention multi-purpose hanger 1 and the modified door hinge pin 31. Present invention hanger 1 includes a frame 3 having a plurality of coat hanger-receiving slots 5, 7, 9 and 11, and small hook 27 (that could support a coat hanger or a shirt or other item with or without a hanger). The slots 5, 7, 9 and 11 are arranged in a sequence so a s to align and space any hangers that are hung on them. The frame 3 has a first end 25 and a second end 15, and a top 21 and a bottom 23. There is a door hinge pin connector 17 at first end 25, but this could be at either one of the first end and the second end. The connector 17 includes a connector member, here a cylindrical vertical portion, and a vertical shaft-receiving orifice (orifice 27 of FIG. 2) that is in and through the connector member for attachment to a door hinge via a modified door hinge pin. In some embodiments, the orifice may not be all the way through the connector member, but could be recess in the bottom thereof. Also, although shown as a circular orifice, the connector orifice could have any shape, as long as it fit onto its modified hinge pin. Importantly, frame 3 also has a closet hanger rod hook 19 for attachment to a closet hanger rod. This is located at second end 15 in this particular embodiment.

Also shown in FIG. 1 is hinge pin 31. This is modified relative to a normal hinge pin and has an upper member 37, a lower member 33 and a divider stop 35 therebetween. This pin 31 replaces a conventional hinge pin on a door hinge. Lower member 33 replaces the regular pin and pin 31 cannot be pushed in further than stop 35, leaving upper member 37 exposed to receive the present invention multi-purpose hanger 1. The upper and lower members may be the same or different thicknesses and the same or different shapes. It is important that the divider stop of these present invention modified pins have at least apportion that is wider than the width of the lower member so that it functions as a stop.

FIG. 2 is a top view of the present invention hanger 1 (without the pin) as shown in FIG. 1. In this embodiment, the hanger 1 is elongated and flat from a footprint view. Orifice 27 is circular and may pass all of the way through the connector 17.

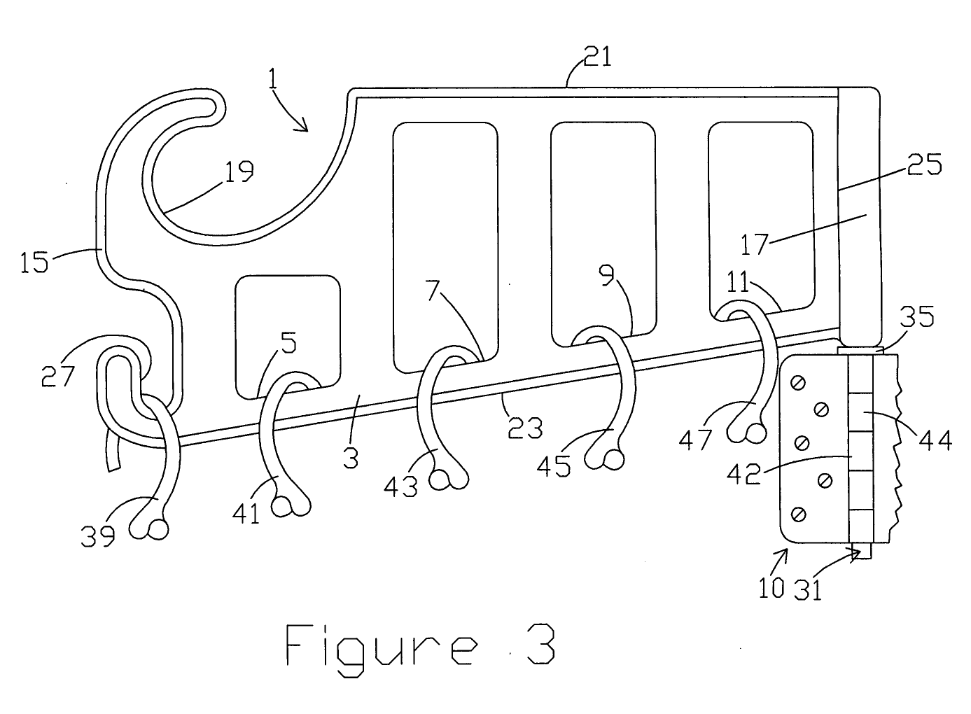

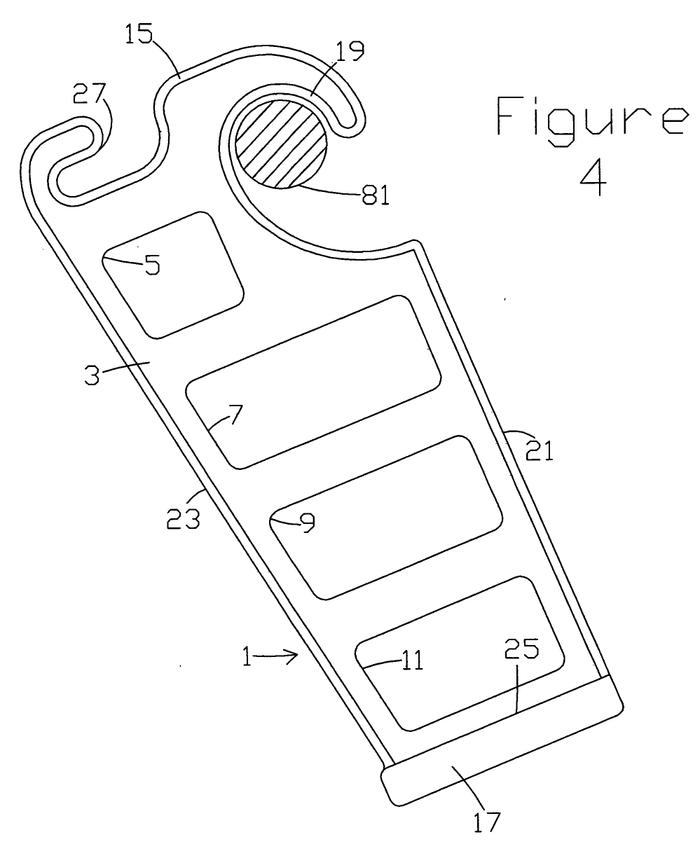

FIG. 3 is a side view of the multi-purpose hanger system according to the present invention as shown in FIG. 1, illustrating the present invention hanger 1 and the modified door hinge pin 31 assembled together on a door hinge 10. The door hinge 10 has a door component 42 and a door jamb component 44 and pin 31 passes through and hingeably connects them as would a normal pin. Hanger 1 is set onto the top member of pin 31, as shown. In this FIG. 3, a partial view of a plurality of clothes hangers 39, 41, 43, 45 and 47 are shown.

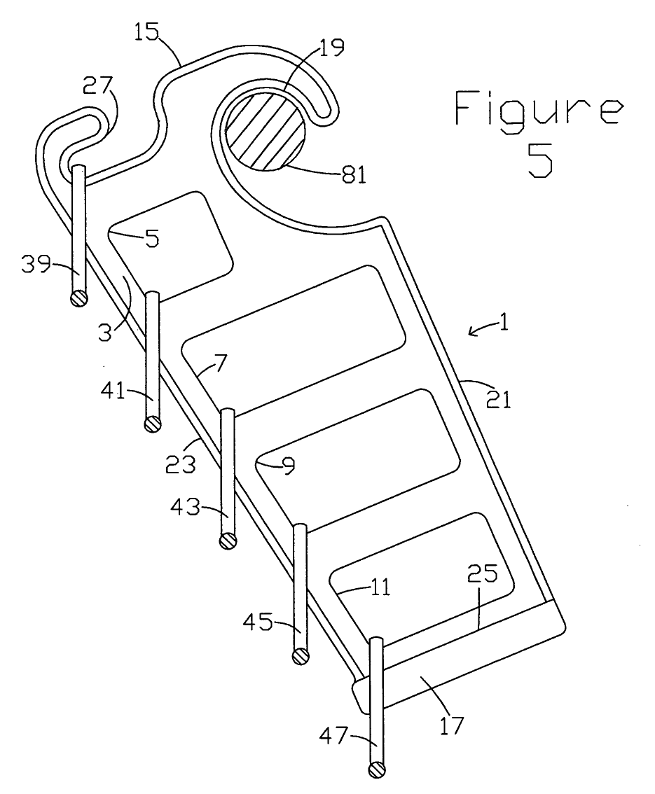

FIG. 4 is a side view of the multi-purpose hanger 1 according to FIGS. 1 through 3, but shown hanging on a closet rod 81 by hook 19, instead of being on a present invention modified door hinge pin, as previously shown.

FIG. 5 is a side view of the multi-purpose hanger 1 according to FIG. 4, shown hanging on a closet rod 81, but with partial sections of clothes hangers 39, 41, 43, 45 and 47 added to show the arrangement of coat hangers on the present invention multi-purpose hanger 1.

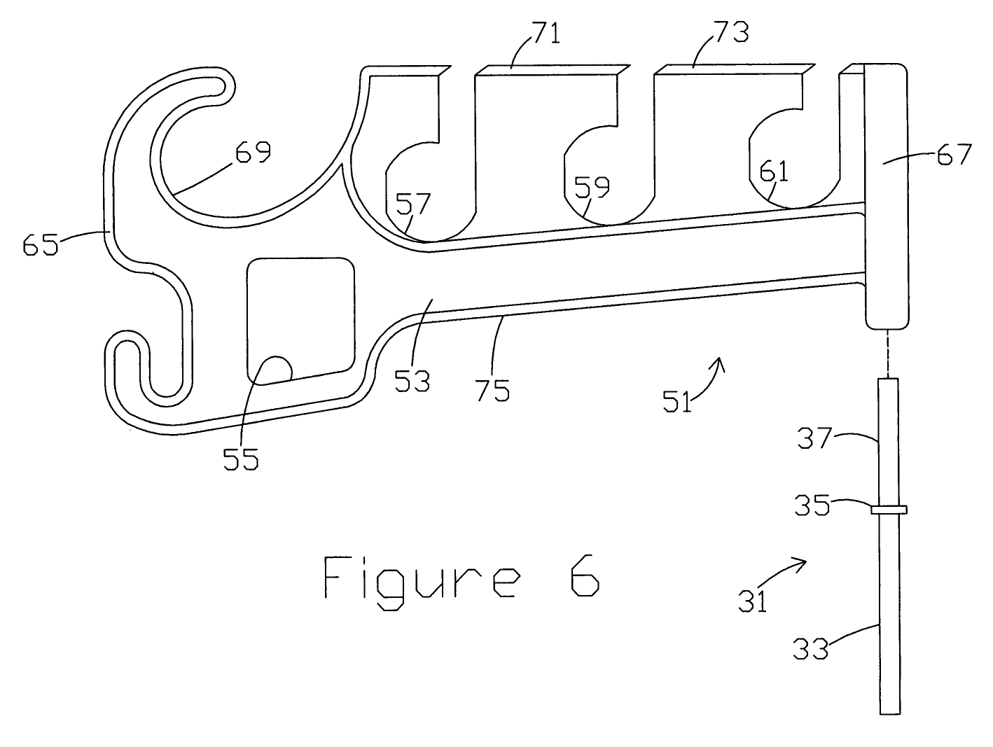

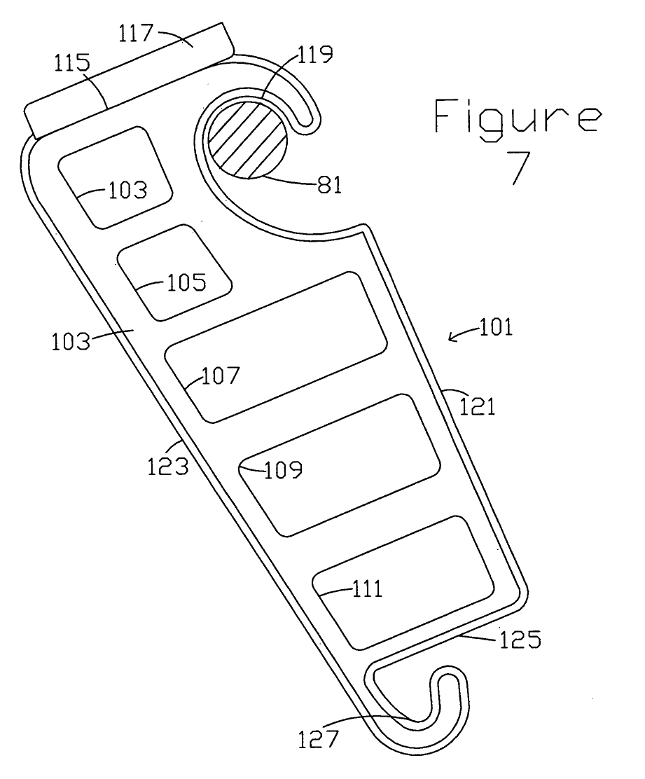

FIG. 6 is an alternative embodiment present invention multi-purpose hanger system, including a modified hinge pin 31. The hinge pin 31 is described above and identical parts are numbered identically. Further, the functionality of pin 31 is the same here as is described above. Present invention multi-purpose hanger 51 includes a frame 53, with a top having sections such as sections 71 and 73. Hanger slots 55, 57, 59 and 61 are provided, with one being closed and the other being open slots. It has a connector 67 at one end 65 and a rod hook 69 at the opposite end 65. It functions similarly to hanger 1 described above, but hangers may be put onto the slots through the side or through the open top.

FIG. 7 is another alternative embodiment present invention multi-purpose hanger 101, with a frame 103 with a top 121 and a bottom 123, as well as a first end 125 and a second end 115. It has a plurality of slots 103, 105, 107, 109 and 111, and end coat hook 127. Here, both the rod hook 119 and the hinge pin connector 117 are at the same end of the device, i.e., end 115.

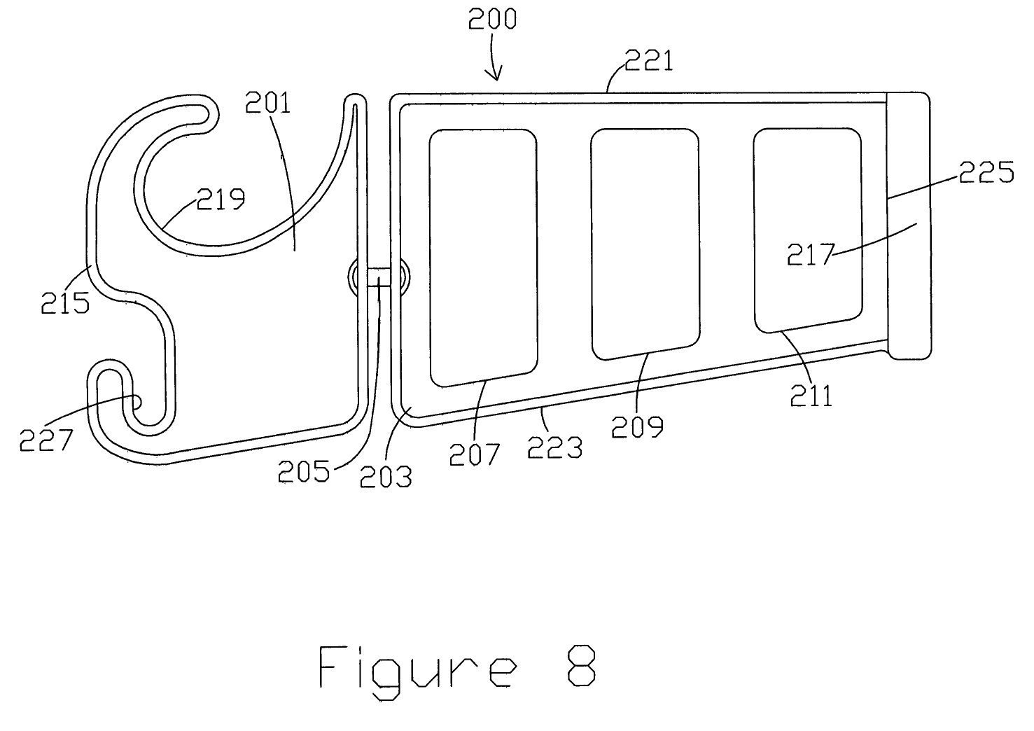

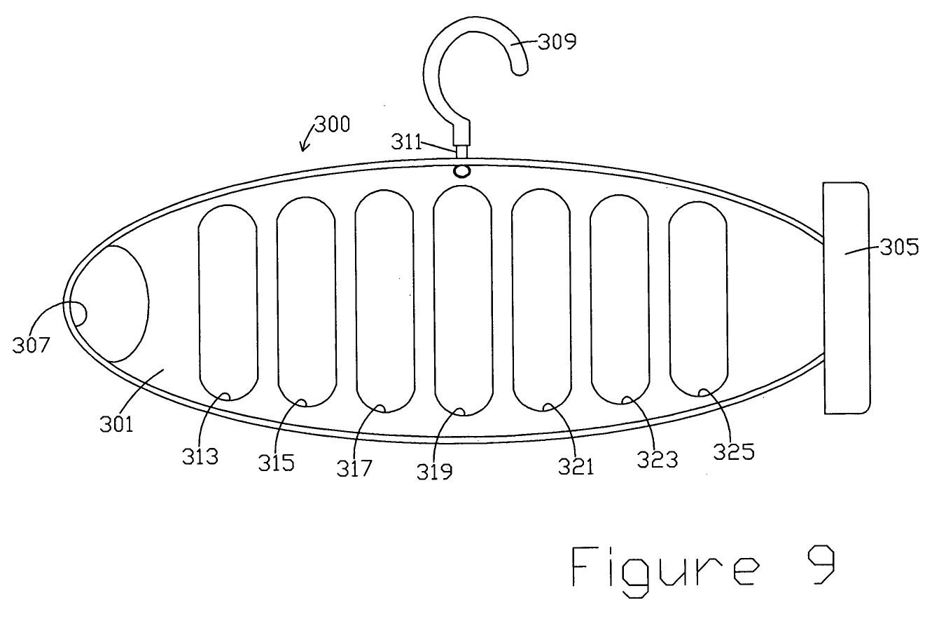

FIG. 8 is yet another alternative embodiment present invention multi-purpose hanger 200, this one being articulated so that the hook section 201 and the clothes hanger slots section 203 are able to swivel (rotate) relative to one another. Hanger 200 has coat hanger slots 207, 209 and 211 and has a first end 215 with rod hook 219 located thereon, and has a second end 225 with hinge connector 217 located thereon. Connecting shaft 205 enables section 201 to be rotated relative to section 203, so that, for example, hook 219 may be hung on a rod and section 203 may swiveled to a right angle from the hook so as to align hanging clothes to line up with other hangers on the same rod.

FIG. 9 is an alternative embodiment present invention multi-purpose hanger 300 that is articulated for swiveling and has an oval shape. Main frame 301 has an oval shape, but it could be round, rectangular or otherwise, and has a handle slot 307 and a hinge connector 305. It also has a plurality of coat hanger slots 313, 315, 317, 321, 323 and 325. The rod hook 309 is a separate, rotatable piece, connected by rotational shaft pin 311, so that, again, hanging clothes may be swiveled as needed relative to the rod hook 309.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A multi-purpose hanger, which comprises:
a frame having a plurality of coat hanger-receiving slots, said slots being arranged in a sequence, said frame having a first end and a second end, and having a door hinge pin connector at one of said first end and said second end, said connector having a connector member and having a vertical shaft-receiving orifice in said connector member for attachment to a door hinge and door hinge pin, said frame also having a closet hanger rod hook for attachment to a closet hanger rod.

2. The multi-purpose hanger of claim 1 wherein said slots are closed slots.

3. The multi-purpose hanger of claim 1 wherein said slots are open slots.

4. The multi-purpose hanger of claim 1 wherein said connector is at said first end of said frame and said hook is at said second end of said elongated frame.

5. The multi-purpose hanger of claim 1 wherein said frame is elongated in a horizontal direction, said connector being located at said first end of said elongated frame, said hook being located at said second end of said elongated frame.

6. The multi-purpose hanger of claim 1 wherein said connector is at said first end of said frame and said hook is at said first end of said elongated frame.

7. The multi-purpose hanger of claim 1 wherein said multipurpose hanger is a single piece of material.

8. The multi-purpose hanger of claim 1 wherein said multipurpose hanger is a material selected from the group consisting of plastic, metal and combinations thereof.

9. The multi-purpose hanger of claim 1 wherein said frame has a first section that includes said hook and a second section that includes plurality of said coat hanger-receiving slots, and wherein said first section and said second section are rotatably connected to one another so as to be swiveled relative to one another.

10. A multi-purpose hanger system, which compromises:
a) a multi-purpose hanger, said multi-purpose hanger being an elongated frame having a plurality of coat hanger-receiving slots, said slots being arranged in a sequence, said frame having a first end and a second end, and having a door hinge pin connector at one of said first end and said second end, said connector having a connector member and having a vertical shaft-receiving orifice in and through said connector member for attachment to a door hinge and door hinge pin, said frame having a closet hanger rod hook at one of said first end and said second end for attachment to a closet hanger rod; and,
b) a door hinge pin having an elongated shaft, said elongated shaft having an upper member, a lower member and a divider stop located between said upper member and said lower member, said upper member having a first maximum width and said lower member having a second maximum width and said stop having a third maximum width, wherein said third maximum width is greater than said second maximum width, and wherein said lower member is adapted to fit into a door hinge pin receiver, said stop is adapted to rest atop of said door hinge pin receiver and not fit into said door hinge pin receiver, and said upper member is adapted to fit into said vertical shaft receiving orifice of said multipurpose hanger.

11. The multi-purpose hanger system of claim 10 wherein one of said upper member and said lower member of said door hinge pin is circular from a top view.

12. The multi-purpose hanger system of claim 10 wherein said hanger slots are closed slots.

13. The multi-purpose hanger system of claim 10 wherein said hanger slots are open slots.

14. The multi-purpose hanger system of claim 10 wherein said connector is at said first end of said elongated frame and said hook is at said second end of said elongated frame.

15. The multi-purpose hanger system of claim 10 wherein said elongated frame is elongated in a horizontal direction, said connector being located at said first end of said elongated frame, said hook being located at said second end of said elongated frame.

16. The multi-purpose hanger system of claim 10 wherein said connector is at said first end of said elongated frame and said hook is at said first end of said elongated frame.

17. The multi-purpose hanger system of claim 10 wherein said multipurpose hanger is a single piece of material.

18. The multi-purpose hanger system of claim 10 wherein said multipurpose hanger is a material selected from the group consisting of plastic, metal and combinations thereof.

19. The multi-purpose hanger of claim 18 wherein said elongated frame has a first section that includes said hook and a second section that includes said plurality of coat hanger-receiving slots, and wherein said first section and said second section are rotatably connected to one another so as to be swiveled relative to one another.

20. The multi-purpose hanger system of claim 1, wherein said door hinge pin upper member maximum width is the same as said lower member maximum width.
